(19) United States
(12) Patent Application Publication
(10) Pub. No.: US 2007/0290023 A1
(43) Pub. Date: Dec. 20, 2007

(54) TOOL FOR COATING PENETRATING HOLES OF HEAT-DISSIPATING FINS

(76) Inventor: Phon-Quan LEE, Chung-Ho City (TW)

Correspondence Address: HDSL, 4331 STEVENS BATTLE LANE, FAIRFAX, VA, 22033, US

(21) Appl. No.: 11/748,558

(22) Filed: May 15, 2007

(30) Foreign Application Priority Data
May 25, 2006 (TW) 095209042

(51) Int. Cl. B23K 1/00

(52) U.S. Cl. 228/25

(57) ABSTRACT

A tool for coating a heat-conducting medium on penetrating holes of heat-dissipating fins mainly includes a hollow pipe body. One end of the pipe body has an annular recessed portion. The upper and lower ends of the recessed portion are formed respectively with an annular guiding slope. Further, on the recessed portion, a plurality of outlet holes is distributed in a circumferential manner. A plurality of supporting pillars is formed between adjacent outlet holes. When the tool penetrates into the penetrating holes of the heat-dissipating fins, a user may apply an external force to the other end of the pipe body, so as to cause the heat-conducting medium within the pipe body to overflow via the outlet holes. The overflowing heat-conducting medium fills the annular recessed portion first. Further, during the drawing operation of the tool, the heat-conducting medium is uniformly coated on the inner edge surfaces of the penetrating holes of the heat-dissipating fins, thereby filling the gap between the heat-conducting pipe and the fins.

### BACKGROUND OF THE INVENTION

1. Field of the Invention

The present invention relates to a coating tool, and in particular to a coating tool for coating a heat-conducting medium on heat-dissipating fins.

2. Description of Prior Art

As far as a current heat dissipator having a heat-dissipating fin assembly is concerned, in order to improve the heat-dissipating performance of the heat-dissipating fin assembly, a heat-conducting pipe is often provided to penetrate through the heat-dissipating fin assembly. The interior of the heat-conducting pipe is provided with working fluid and capillary structure that are used to perform heat exchange with a heat source on the heat-dissipating fin assembly. In this way, the heat-dissipating fin assembly can absorb the heat conducted from the heat-conducting pipe and dissipate the heat to the outside rapidly.

In the heat-dissipating fin assembly, the fin assembly is constituted of a plurality of heat-dissipating pieces. Each of the heat-dissipating pieces is provided with at least one penetrating hole, while the penetrating hole on each fin corresponds to one another. In order to provide the heat-conducting pipe on the heat-dissipating fin assembly easily, the cross-sectional diameter of the penetrating hole on the fin is slightly larger than that of the heat-conducting pipe, so that the heat-conducting pipe can penetrate into the penetrating holes of the fins assembly. However, since the cross-sectional diameter of the penetrating hole is larger than that of the heat-conducting pipe, a gap is formed between the heat-conducting pipe and the penetrating hole. Accordingly, the heat resistance increases, which lowers the heat-conducting efficiency.

Therefore, in prior art, before the heat-conducting pipe penetrates into the penetrating holes of the fins assembly, a heat-conduct medium having high heat conductivity is coated on the periphery of the penetrating hole. Then, the heat-conducting pipe is disposed to penetrate into the penetrating holes. The heat-conducting medium is used to fill the gap, so that the heat-conducting pipe is tightly connected with the penetrating holes. However, the prior art cannot coat the heat-conducting medium to the periphery of the penetrating hole very uniformly, so that there is still a gap between the heat-conducting pipe and a portion of the penetrating hole when the heat-conducting pipe penetrates into the penetrating holes. As a result, a good connection between the heat-conducting pipe and the heat-dissipating fins still cannot be achieved.

In view of the above drawbacks, a conventional art suggests a coating tool 10a for the heat-conducting medium, and the structure thereof is shown in FIG. 1. The tool 10a includes a hollow pipe body 101a. One end of the pipe body 101a is provided with a plurality of outlet holes 102 surrounding the pipe body 101a. The outlet hole 102a is recessed from the surface of the pipe body 101a. A supporting pillar 103a is formed between two outlet holes 102a. Finally, in the rear of the outlet holes 102a, the periphery of the pipe body is provided with an annular scraper 104a. Therefore, after the tool 10a penetrates into the penetrating holes 201a of the plurality of heat-dissipating pieces 20a, as shown in FIG. 2, a user applies an external force to the other end of the pipe body 101a, thereby causing the heat-conducting medium within the pipe body 101a to overflow via the outlet hole 102a. At the same time, the user draws the pipe body 101a backwardly. During the drawing operation of the pipe body, the scraper 104a provided on the pipe body 101a will cause the overflowing heat-conducting medium to be coated uniformly on the inner edge surface of the penetrating holes 201a of the heat-dissipating pieces 20a according to the movement of the pipe body 101a.

However, after the heat-conducting medium overflows via the outlet hole 102a, since the outer surface of the supporting pillar 103a and the outer surface of the pipe body 101a are coplanar, the flowing of the heat-conducting medium is obstructed and thus cannot be coated on the periphery of the penetrating hole 201a uniformly. Although the scraper 104a provided in the rear of the pipe body can be used to spread the heat-conducting medium uniformly during the drawing operation of the pipe body, the heat-conducting medium still cannot be pushed to the positions obstructed by the supporting pillars 103a and thus generates gaps as shown in FIG. 3. Therefore, it is a primary problem in this tool 10a.

### SUMMARY OF THE INVENTION

Therefore, in view of the above drawbacks, the present invention is to provide a tool for coating a heat-conducting medium on penetrating holes of heat-dissipating fins. With annular recessed outlet holes, the overflowing heat-conducting medium can be distributed on the periphery of the pipe body uniformly, and be coated on the periphery of the penetrating hole uniformly during the drawing operation without generating any dead space. As a result, a good connection between the heat-conducting pipe and the penetrating holes can be achieved.

In order to achieve the above objects, the present invention provides a tool for coating penetrating holes of heat-dissipating fins, which is mainly constituted of a hollow pipe body. One end of the pipe body has an annular recessed portion. The upper and lower ends of the recessed portion are formed respectively with an annular guiding slope. Further, on the recessed portion, a plurality of outlet holes is distributed in a circumferential manner. A plurality of supporting pillars is formed between adjacent outlet holes. When the tool penetrates into the penetrating holes of the heat-dissipating fins, a user may apply an external force to the other end of the pipe body, so as to cause the heat-conducting medium within the pipe body to overflow via the outlet holes. The overflowing heat-conducting medium fills the annular recessed portion first. During the drawing operation of the pipe body, the heat-conducting medium is uniformly coated on the inner edge surface of the penetrating holes of the heat-dissipating fins, thereby filling the gap between the heat-conducting pipe and the fins.

### BRIEF DESCRIPTION OF THE DRAWINGS

FIG. 1 is a perspective view showing the structure of a conventional art;

FIG. 2 is a schematic view showing the operation of a conventional art;

FIG. 3 is a cross-sectional view showing the operation of a conventional art;

FIG. 4 is a perspective view showing the structure of the present invention;

FIG. 5 is a partially enlarged perspective view showing the structure of the present invention;

FIG. 6 is a partially enlarged cross-sectional view of the present invention;

FIG. 7 is a schematic view showing the operation of the present invention;

FIG. 8 is a cross-sectional view showing the operation of the present invention;

FIG. 9A is a schematic view showing the structure of the scraper of another embodiment of the present invention; and

FIG. 9B is a schematic view showing the structure of the scraper of a further embodiment of the present invention.

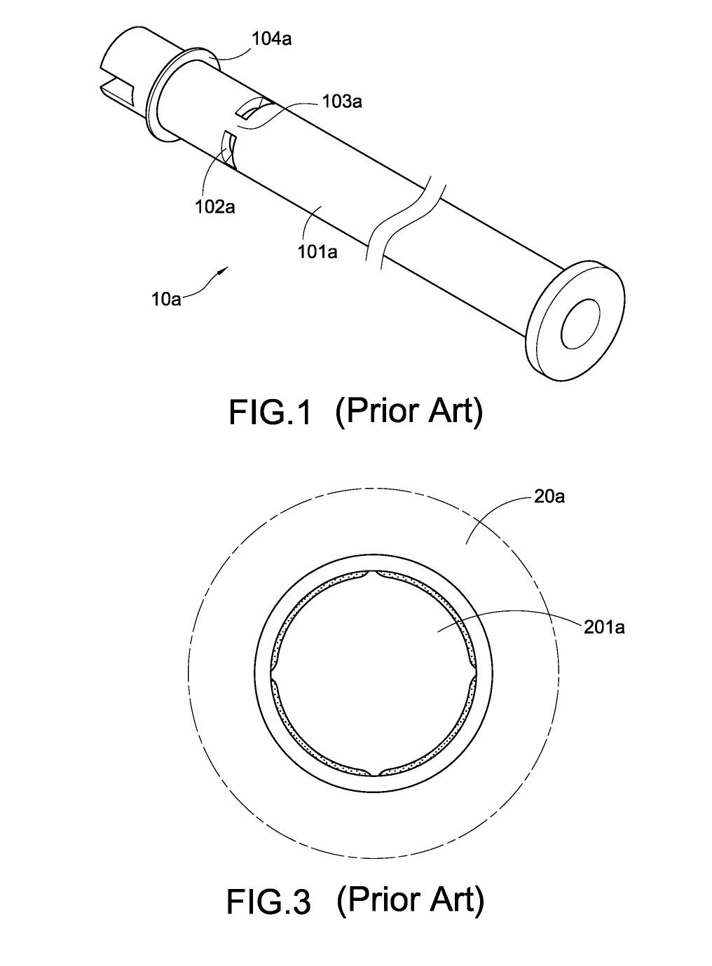

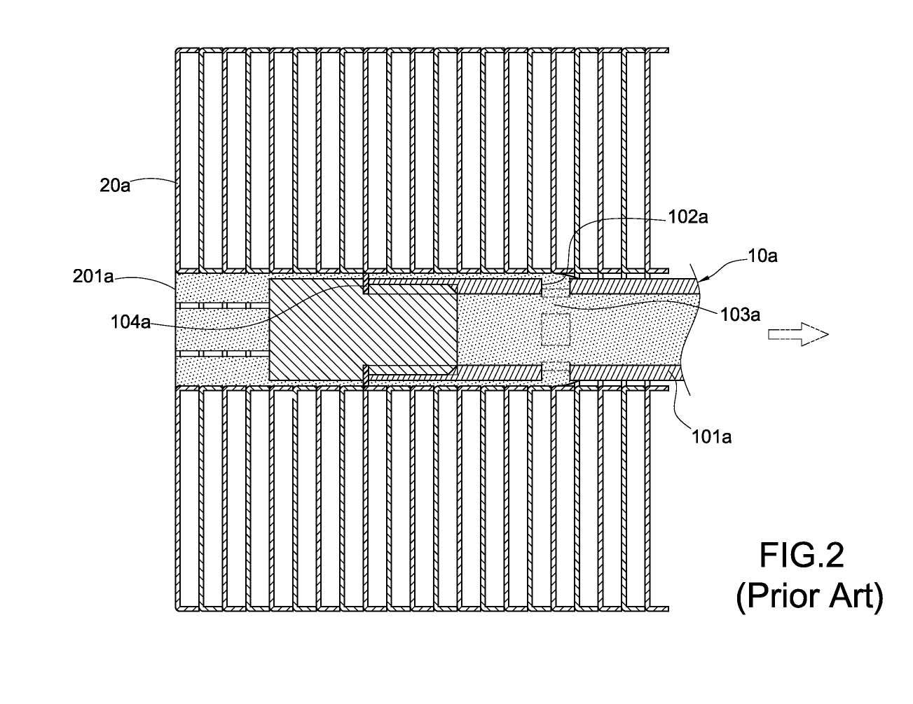

### DETAILED DESCRIPTION OF THE INVENTION

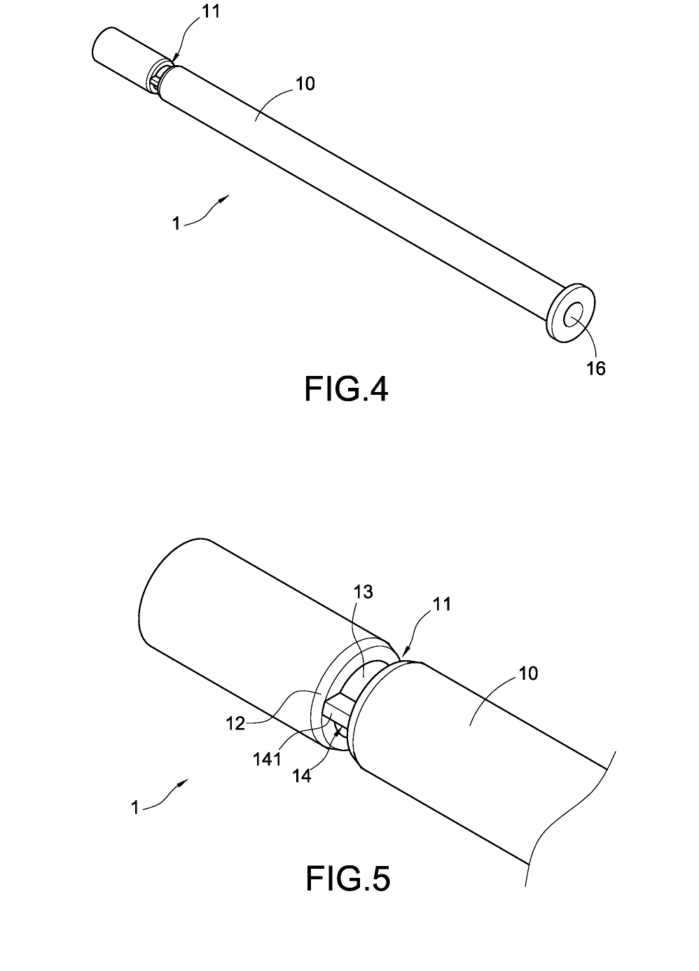

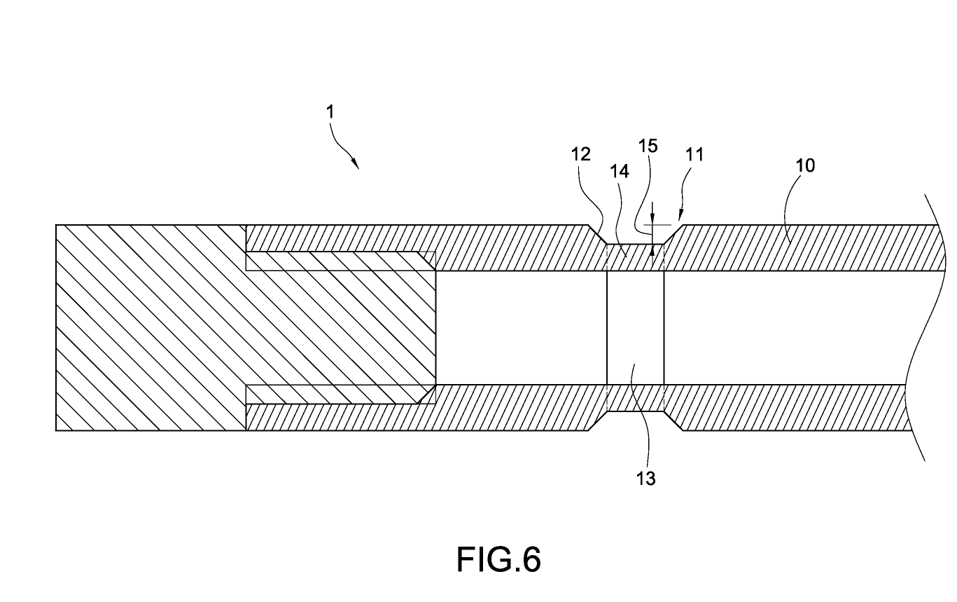

With reference to FIGS. 4 and 5, they are perspective views showing the structure of the present invention. The tool of the present invention is mainly constituted of a hollowed pipe body 10. The bottom of the pipe body 10 has an injection port 16 for filling a heat-conducting medium 3 such as solder paste into the pipe body 10. One end of the pipe body 10 has an annular recessed portion 11. The upper and lower ends of the recessed portion 11 are formed with an annular guiding slope 12 inclining to an axial line of the pipe body 10. In the present embodiment, the guiding slope 12 is formed into a slope (or an arc). The center of the recessed portion 11 is provided with a plurality of outlet holes 13 (two holes shown in the drawing). The plurality of outlet holes 13 is distributed in a circumferential manner. A supporting pillar 14 is provided between the adjacent outlet holes 13. Further, since the guiding slope 12 retracts inwardly toward the axial line of the pipe body 10, a drop distance 15 is formed between the outer surface 141 of the supporting pillar 14 and the pipe surface of the pipe body 10, as shown in the cross-sectional view of FIG. 6.

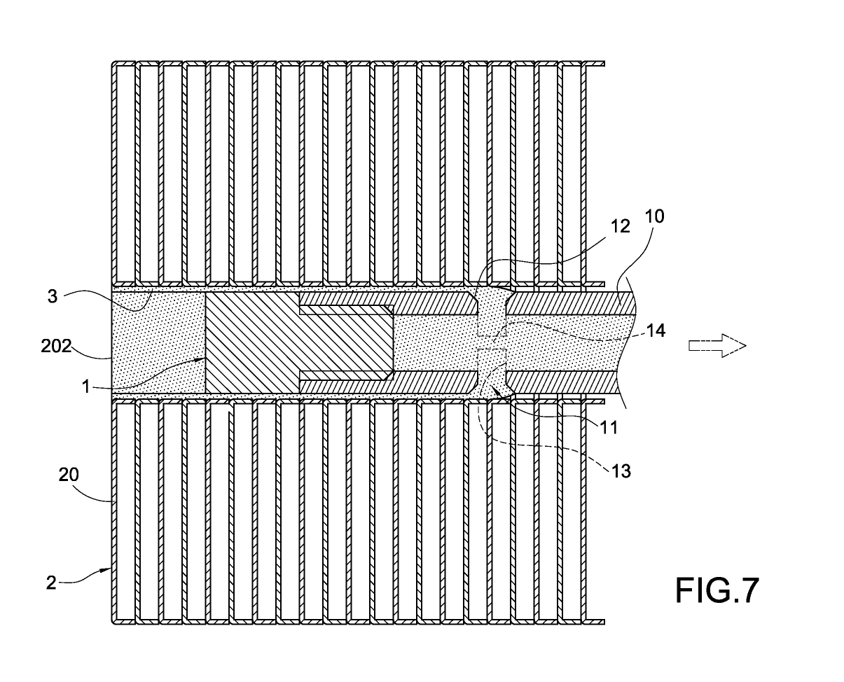

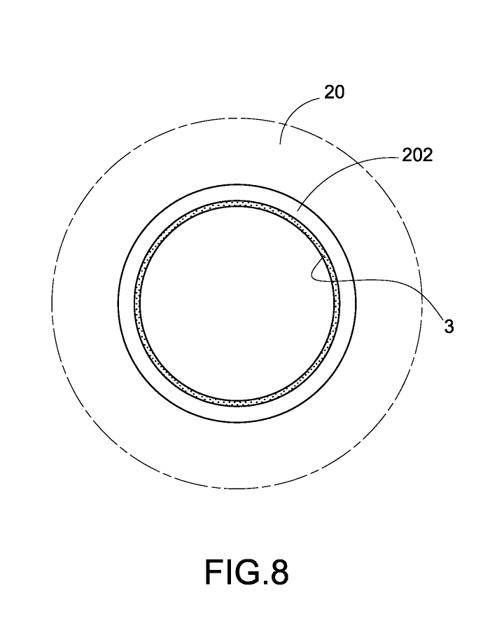

With reference to FIG. 7, it is a schematic view showing the operation of the present invention. As shown in this figure, the heat-dissipating fins assembly 2 is formed by stacking up a plurality of heat-dissipating fins 20 at the same interval. Each heat-dissipating fin 20 is provided with a left and a right penetrating holes 202. The penetrating hole 202 allows a heat-conducting pipe (not shown) to be penetrated therein, which belongs a conventional art and thus the description thereof is omitted. Before the heat-conducting pipe penetrates into the penetrating holes 202 of the heat-dissipating fins 20, the coating tool 1 penetrates into the penetrating holes 202 of the heat-dissipating fins 20. Then, the heat-conducting medium 3 is injected into the injection port 16 (not shown) on the other end of the pipe body. The user applies an external force to press the pipe body, so that the heat-conducting medium 3 within the pipe body 10 can overflow via the outlet hole 13. At the same time, after the heat-conducting medium 3 overflows via the outlet hole 13, the heat-conducting medium 3 will first flow along the annular guiding slope 12 that is provided at the outside of the outlet hole 13. Also, since the supporting pillar 14 provided in the recessed portion 11 retracts inwardly and a drop distance 15 is formed between the supporting pillar and the pipe body 10, the heat-conducting medium 3 can flow leftward and rightward easily and fill the space formed by the annular recessed portion 11 first. Then, the pipe body 10 of the tool 1 is drawn out of the penetrating hole 202 along the path formed by the plurality of penetrating holes 202. During the drawing operation, via an externally pressing action, the heat-conducting medium 3 overflows and is coated on the inner walls of the penetrating holes 202 of the heat-dissipating fins 20 uniformly according to the movement of the pipe body 10, as shown in FIG. 8. Finally, the heat-conducting pipe penetrates into the penetrating holes 202 of the heat-dissipating fins 20 and is subjected to heating and cooling operations, so that the heat-conducting pipe can be firmly adhered onto the heat-dissipating fins 20 by means of the heat-conducting medium 3.

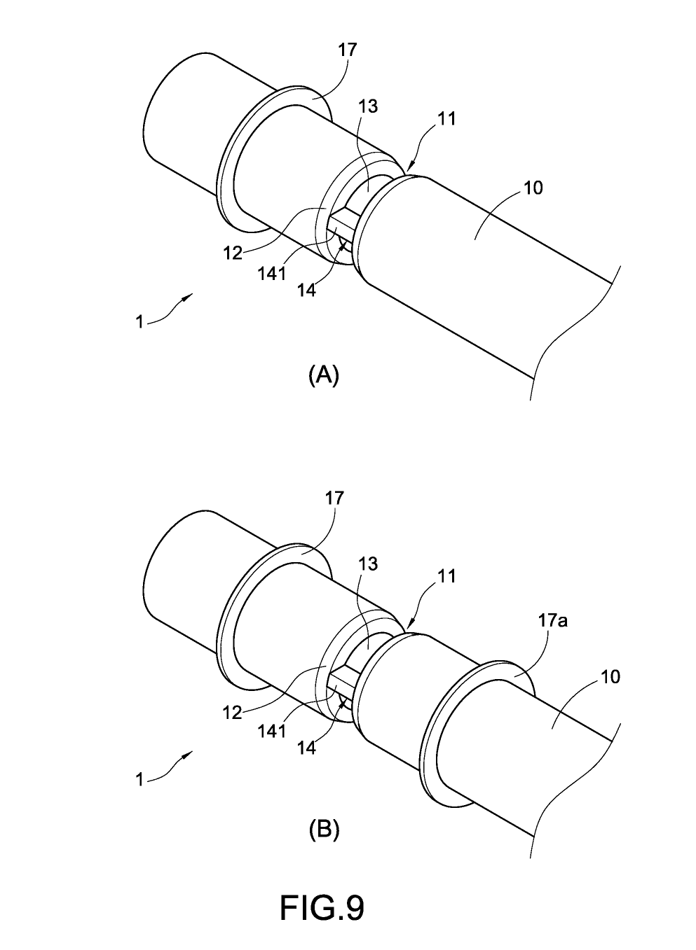

FIG. 9A is a schematic view showing the structure of the tool of another embodiment of the present invention, and FIG. 9B is a schematic view showing the structure of the tool of a further embodiment of the present invention. As shown in FIG. 9A, an annular scraper 17 is provided in front of the recessed portion 11 of the pipe body 10. The pipe body 10 provided with the annular scraper 17 penetrates into the penetrating holes 202 of the heat-dissipating fins assembly 2. A gap is formed between the scraper 17 and the penetrating hole 202. The scraper 17 is flexible, so that it can apply the overflowing heat-conducting medium 3 on the inner edges of the penetrating holes 202 of the heat-dissipating fins 20 more uniformly according to the movement of the pipe body 10. Further, another annular scraper 17a is provided in back of the recessed portion 11, as shown in FIG. 9B. In addition to block the heat-conducting medium 3 from flowing downwardly, the above arrangement can also maintain the stability of the pipe body 10 during the drawing operation of the pipe body 10.

Although the present invention has been described with reference to the foregoing preferred embodiments, it will be understood that the invention is not limited to the details thereof. Various equivalent variations and modifications may still occur to those skilled in this art in view of the teachings of the present invention. Thus, all such variations and equivalent modifications are also embraced within the scope of the invention as defined in the appended claims.

What is claimed is:

1. A tool for coating penetrating holes of heat-dissipating fins, comprising a hollow pipe body, one end of the pipe body being provided with an annular recessed portion, upper and lower ends of the recessed portion being formed respectively with an annular guiding slope, a periphery of the recessed portion being provided with a plurality of outlet holes, a supporting pillar being formed between adjacent said outlet holes, a drop distance being formed between an outer surface of the supporting pillar and a pipe surface of the pipe body since the guiding slope retracts inwardly toward an axial line of the pipe body, and another end of the pipe body having an injection port.

2. The tool for coating penetrating holes of heat-dissipating fins according to claim 1, wherein the guiding slope is formed into a slope.

3. The tool for coating penetrating holes of heat-dissipating fins according to claim 1, wherein the guiding slope is formed into an arc.

4. The tool for coating penetrating holes of heat-dissipating fins according to claim 1, wherein at least an annular scraper is provided on a periphery of the pipe body adjacent to the recessed portion.
